(19) United States
(12) Patent Application Publication
(10) Pub. No.: US 2015/0053074 A1
(43) Pub. Date: Feb. 26, 2015

(54) Fluid-Pressure Drive Device for Circuit Breaker

(71) Applicant: Hitachi, Ltd., Tokyo (JP)

(72) Inventors: Shinji SETO, Tokyo (JP); Daisuke EBISAWA, Tokyo (JP)

(21) Appl. No.: 14/451,130

(22) Filed: Aug. 4, 2014

(30) Foreign Application Priority Data
Aug. 23, 2013 (JP) 2013-172822

(51) Int. Cl. F15B 15/22; H01H 33/34; F15B 15/17

(52) U.S. Cl. CPC F15B 15/22; F15B 15/17; H01H 33/34
USPC 91/416

(57) ABSTRACT

The drive device includes: a contact including a moving contact and a stationary contact; a rod connected to the moving contact; a piston which is connected to the rod and is slidably installed in a cylinder and which opens and closes the contact; a fluid pressure source for pressure-feeding a working fluid; and a control valve for driving the piston. In the drive device, the piston forms a partition between a supply pressure chamber communicated with the fluid pressure source and a small pressure-receiving area chamber which are on the moving contact side of the piston and a cylinder control chamber on the opposite side of the piston, and the control valve controls supplying and discharging the working fluid to and from the cylinder control chamber.

### CLAIM OF PRIORITY

The present application claims priority from Japanese Patent application serial no. 2013-172822, filed on Aug. 23, 2013, the content of which is hereby incorporated by reference into this application.

### FIELD OF THE INVENTION

The present invention relates to a fluid-pressure drive device for a circuit breaker and, more particularly, to a fluid-pressure drive device for a circuit breaker suitable for suppressing a pressure rise when braking an opening operation.

### BACKGROUND OF THE INVENTION

An example of background technique in the field relevant to the present invention is disclosed in Japanese Unexamined Patent Publication No. 1989-279525. In the patent publication, it is stated that a liquid-pressure operation device for a circuit breaker is provided which offers sealing performance and component strength with reliability improved by removing a damper chamber contributing to a buffering effect toward the end of a piston stroke and by suppressing a pressure rise during a buffering action (see the abstract).

In the liquid-pressure operation device disclosed in the patent literature, a flow control valve which is structured to decrease a flow-path cross-sectional area of high-pressure piping by moving a spool valve having a valve rod on each side thereof is installed in an intermediate portion of the high-pressure piping. Each valve rod extends to outside the spool valve casing via a packing, and one of the two valve rods is engaged, using a rotary lever, with a rod connected to a piston. In this structure, reducing the flow-path cross-sectional area requires use of another valve. Also, the device structure is complicated with the piston and one of the valve rods engaged with each other using the rotary lever.

The present invention has been made in view of the above problems, and an object of the present invention is to provide a low-cost, high-reliability fluid-pressure drive device for a circuit breaker which has a simple structure for suppressing a pressure rise when the piston is braked toward the end of its stroke.

### SUMMARY OF THE INVENTION

To achieve the above object, the fluid-pressure drive device for a circuit breaker according to the present invention includes: a contact for passing and cutting off an electric current, the contact including a moving contact and a stationary contact; a rod connected to the moving contact; a piston which is connected to the rod and is slidably installed in a cylinder and which opens and closes the contact; a fluid pressure source for pressure-feeding a working fluid into the cylinder; and a control valve for driving the piston. In the fluid-pressure drive device: the piston forms a partition between a supply pressure chamber communicated with the fluid pressure source and a small pressure-receiving area chamber which are on the moving contact side of the piston and a cylinder control chamber on the opposite side of the piston; the control valve controls supplying and discharging the working fluid to and from the cylinder control chamber; and, when the piston starts opening operation, the cross-sectional area of a flow path formed, for the working fluid, between the supply pressure chamber and the small pressure-receiving area chamber increases compared with before the piston started moving and subsequently, when the piston is to be decelerated, decreases compared with immediately after the piston started moving.

According to the present invention, a low-cost, high-reliability fluid-pressure drive device for a circuit breaker can be realized which has a simple structure for suppressing a pressure rise in a buffer chamber by changing the flow-path cross-sectional area according to movement of the piston.

### BRIEF DESCRIPTION OF THE DRAWINGS

FIG. 1 is a longitudinal sectional view of a fluid-pressure drive device for a circuit breaker according to a first embodiment of the present invention in a closed state.

FIG. 2 is a longitudinal sectional view of the fluid-pressure drive device for a circuit breaker according to the first embodiment of the present invention in an initial stage of an opening operation.

FIG. 3 is an enlarged view of a vicinity of the supply-side check valve shown in FIG. 2.

FIG. 4 is a longitudinal sectional view of the fluid-pressure drive device for a circuit breaker according to the first embodiment of the present invention in a state during an opening operation.

FIG. 5 is a longitudinal sectional view of the fluid-pressure drive device for a circuit breaker according to the first embodiment of the present invention in a final stage of an opening operation.

FIG. 6 is a longitudinal sectional view of the fluid-pressure drive device for a circuit breaker according to the first embodiment of the present invention in an open state.

FIG. 7 is a longitudinal sectional view of the fluid-pressure drive device for a circuit breaker according to the first embodiment of the present invention in a state during a closing operation.

FIG. 8 is an enlarged view of a vicinity of the cylinder control chamber-side check valve shown in FIG. 7.

FIG. 9 is a perspective view of a supply-side check valve included in the fluid-pressure drive device for a circuit breaker according to the first embodiment of the present invention.

FIG. 10 is a longitudinal sectional view of a fluid-pressure drive device for a circuit breaker according to a second embodiment of the present invention in a closed state.

FIG. 11 is a longitudinal sectional view of the fluid-pressure drive device for a circuit breaker according to the second embodiment of the present invention in a state during an opening operation.

FIG. 12 is an enlarged view of a vicinity of the supply-side check valve shown in FIG. 11.

FIG. 13 is a longitudinal sectional view of a fluid-pressure drive device for a circuit breaker according to a third embodiment of the present invention in a closed state.

### DETAILED DESCRIPTION OF THE PREFERRED EMBODIMENTS

Embodiments of the present invention will be described below with reference to drawings. Being described in the following are exemplary embodiments of the present invention, and they are not intended to limit the scope of the present invention. The present invention can be modified in various ways without departing from the scope of the invention as defined by the appended claims.

### First Embodiment

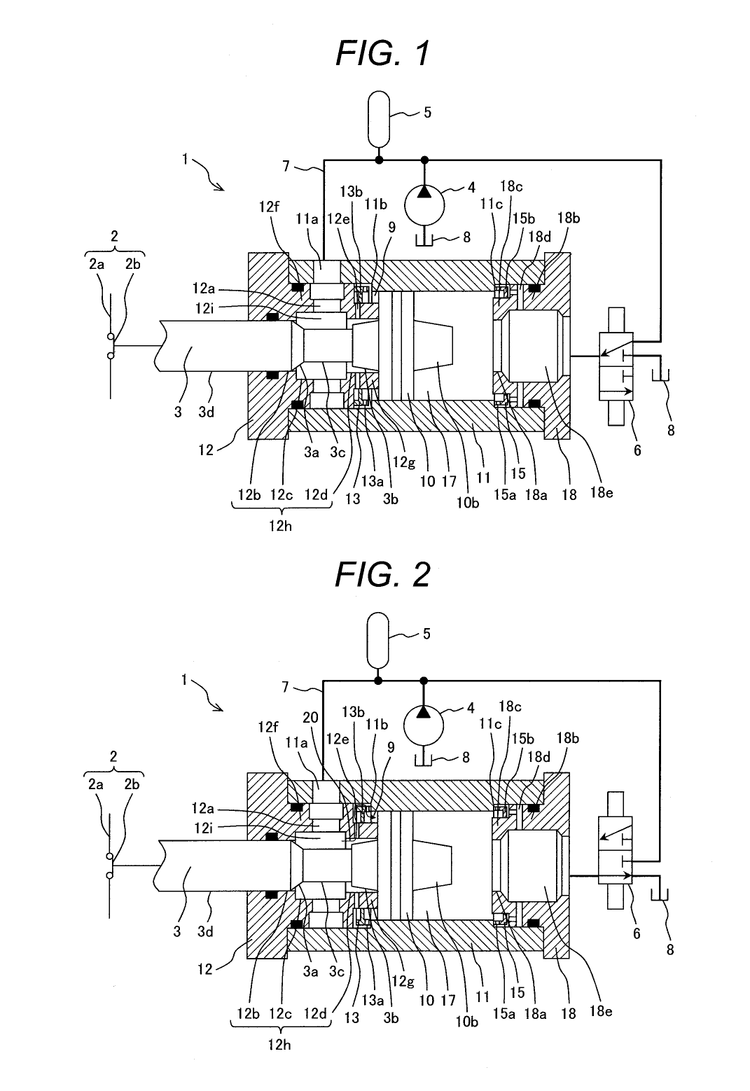

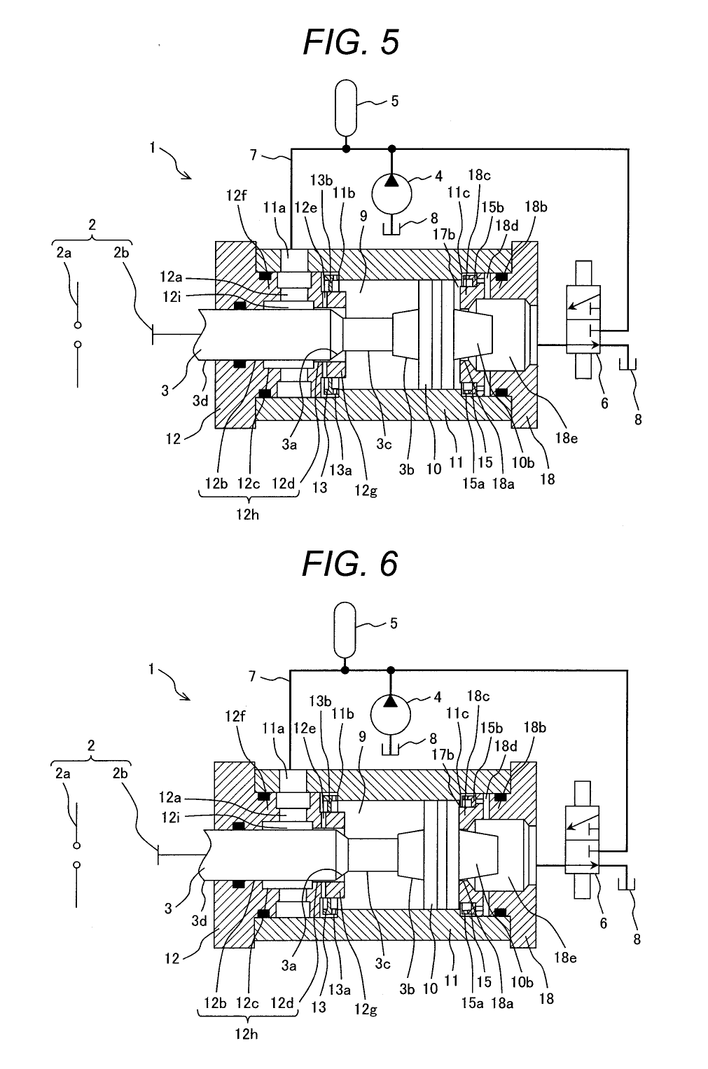

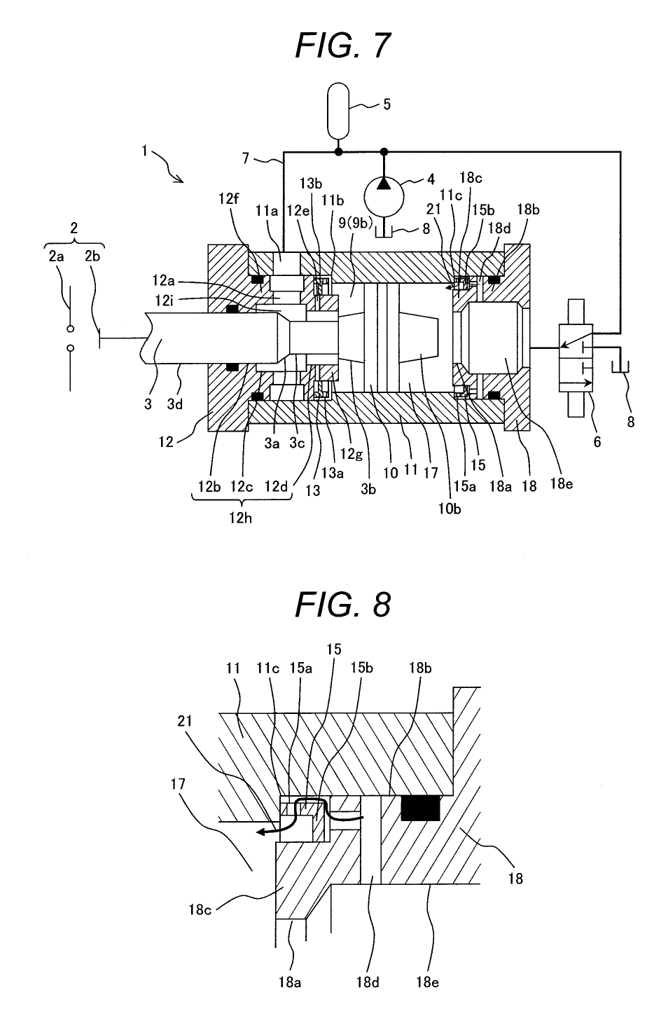

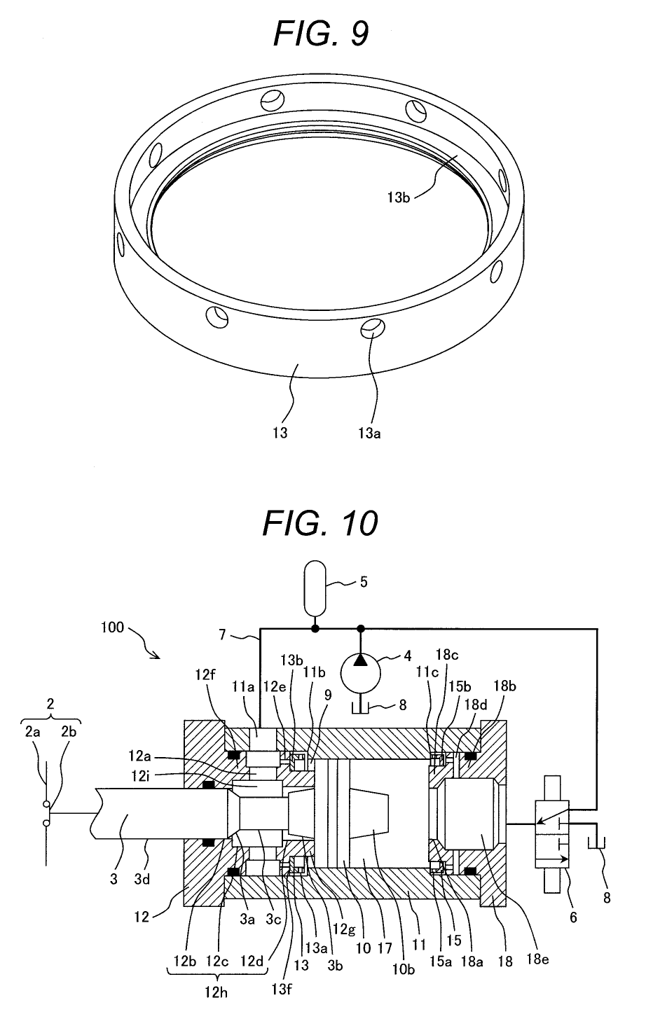

An embodiment of a fluid-pressure drive device for a circuit breaker 1 according to the present invention will be described below with reference to FIGS. 1 to 9. FIG. 1 shows a fluid-pressure drive device for a circuit breaker in an energized closed state. FIG. 2 shows the drive device in a stage of starting an opening operation. FIG. 4 shows the drive device in an intermediate stage of an opening operation. FIG. 5 shows the drive device in a final stage of an opening operation. FIG. 6 shows the drive device in an open state. FIG. 7 shows the drive device in an intermediate stage of a closing operation. FIG. 9 is a perspective view of a check valve on the supply side.

The fluid-pressure drive device for a circuit breaker 1 includes a rod 3 for opening/closing a contact 2, a piston 10 connected to the rod 3, a cylinder 11 in which the piston 10 slides, an accumulator 5 for accumulating a high-pressure working fluid, a fluid pressure source 4 for supplying a high-pressure fluid, and a directional control valve 6 serving as a control valve for pressure switching in the cylinder 11.

The piston 10 is slidable in the cylinder 11, partitions the interior of the cylinder 11 into a small pressure-receiving area chamber 9 on the rod 3 side and a cylinder control chamber 17 on the opposite side, and is connected, via the rod 3, to a moving contact 2b on the moving side of the contact 2. The piston 10 has a projecting portion 10b on the cylinder control chamber 17 side thereof. The projecting portion 10b is shaped to be smaller in cross-sectional area toward the directional control valve 6.

The small pressure-receiving area chamber 9 is constantly subjected to the supply pressure of the working fluid released from the fluid pressure source 4 and accumulated in the accumulator 5. The large pressure-receiving area side of the piston 10 making up the cylinder control chamber 17 is selectively connected, by the directional control valve 6, to a high supply-pressure side or to a low-pressure return side connected to a reservoir 8.

The means of driving the directional control valve 6 is not particularly defined. The directional control valve 6 may be driven, for example, electromagnetically or using a pilot pressure.

The reservoir 8 recovers and stores discharged fluid. In the present embodiment, pressure switching in the cylinder 11 is effected using the directional control valve 6, but the pressure switching means is not limited to a directional control valve. An alternative structure may be adopted in which, for example, an opening control valve and a closing control valve are connected to the low-pressure return side and the high-pressure supply side, respectively.

On the contact 2 side of the cylinder 11, there is a supply-side guide member 12 which has a stepped convex portion including a small-diameter portion 12g and a medium-diameter portion 12f. The supply-side guide member 12 has, at its center, a through-hole 12h through which the rod 3 is inserted. The outer periphery of the medium-diameter portion 12f is fitted in the cylinder 11.

The through-hole 12h in the supply-side guide member 12 has a small-diameter portion 12b, a large-diameter portion 12c, and a supply flow-path forming portion 12d. Of these portions: the small-diameter portion 12b is closest to the contact 2 and has the smallest diameter; the large-diameter portion 12c is on the cylinder control chamber 17 side of the small-diameter portion 12b and has the largest diameter; and the supply flow-path forming portion 12d is on the cylinder control chamber 17 side of the large-diameter portion 12c and has a diameter larger than that of the small-diameter portion 12b and smaller than that of the large-diameter portion 12c. The supply flow-path forming portion 12d makes up a flow path for the fluid flowing from the supply pressure side toward the small pressure-receiving area chamber 9. The large-diameter portion 12c makes up a supply pressure chamber 12i constantly supplied with a supply pressure. The small-diameter portion 12b makes up a sliding portion over which the rod 3 slides.

The medium-diameter portion 12f of the supply-side guide member 12 has one supply through-hole 12a or more. The supply through-hole 12a is connected, via a cylinder supply path 11a formed in the cylinder 11, to a supply path 7 through which the high-pressure working fluid from the accumulator 5 is supplied and is communicated with the supply pressure chamber 12i. The supply pressure chamber 12i is kept at a high pressure equivalent to the pressure in the accumulator 5.

The rod 3 includes, from left to right as seen in FIG. 1, a contact-side sliding portion 3d having a uniform diameter, a decreasing-diameter portion 3a decreasing in diameter toward the piston 10, a uniform small-diameter portion 3c, and an increasing-diameter portion 3b gradually increasing in diameter toward the piston 10. Each of the decreasing-diameter portion 3a and increasing-diameter portion 3b may be formed such that its diameter changes at a uniform rate or at stepped rates, i.e. stepped once or more or consecutively.

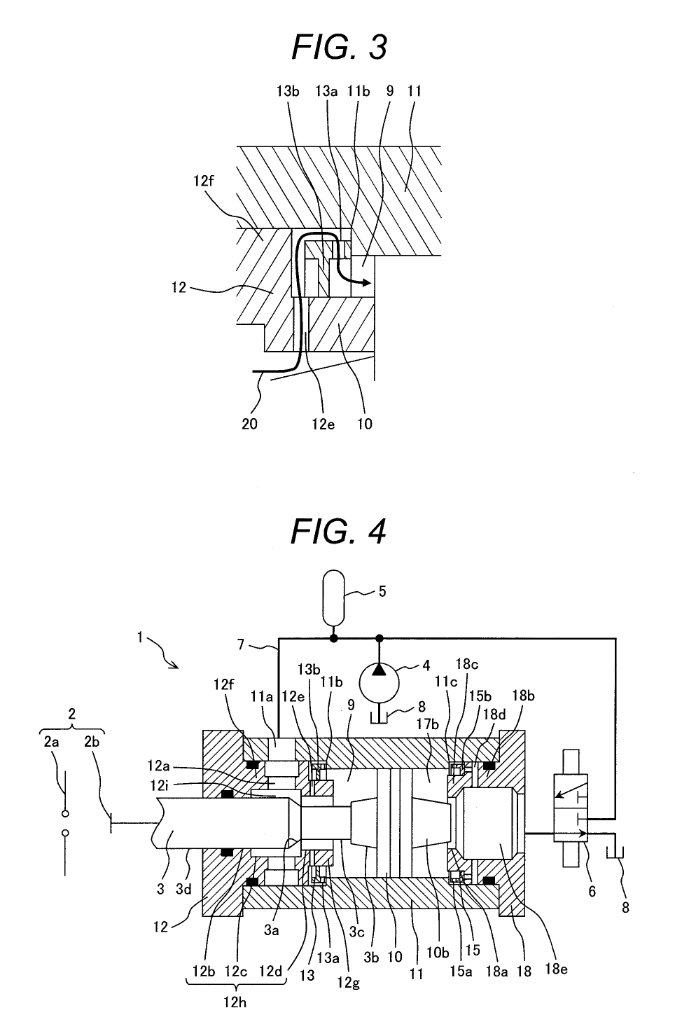

The small-diameter portion 12g of the supply-side guide member 12 has one or more communication paths for check valve 12e allowing communication between inside and outside the small-diameter portion 12g. A supply-side check valve 13 is provided between the outer periphery of the small-diameter portion 12g of the supply-side guide member 12 and the inner periphery of the cylinder 11 (see FIG. 3).

As shown in FIG. 9, the supply-side check valve 13 is cylindrically shaped and has, on the inner side thereof, a small-diameter portion 13b which is convex in a sectional view with an inner diameter smaller than that of the other portion.

The outer diameter of the supply-side check valve 13 is smaller than the larger diameter of a step 11b formed on the contact 2 side of the cylinder 11 (i.e. the inner diameter of the cylinder portion on the contact 2 side of the step 11b). The supply-side check valve 13 also has plural communication paths 13a formed through a cylindrical portion thereof on one side (on the small pressure-receiving area chamber 9 side) of the small-diameter portion 13b. The communication paths 13a allow communication between the inside and outside of the cylindrical portion of the supply-side check valve 13.

The supply-side check valve 13 is installed such that the communication path 13a side thereof comes on the step 11b side in the cylinder 11. The inner diameter of the small-diameter portion 13b of the supply-side check valve 13 is larger than the outer diameter of the small-diameter portion 12g of the supply-side guide member 12 such that the small-diameter portion 13b is slidable without causing much fluid leakage.

The supply-side check valve 13 is movable, by the pressure difference between the left and right sides thereof as seen in FIG. 1, in a stroke motion between an end portion of the medium-diameter portion 12f of the supply-side guide member 12 on the left side and the step 11b formed in the cylinder 11 on the right side. The small-diameter portion 13b of the supply-side check valve 13 is positioned such that the outside outlet of the communication path for check valve 12e is closer to the end portion of the medium-diameter portion 12f of the supply-side guide member 12 than the small-diameter portion 13b of the supply-side check valve 13.

In the above structure, the supply-side check valve 13 is moved by the pressure difference between the small pressure-receiving area chamber 9 side and the communication path for check valve 12e in the supply-side guide member 12. When the pressure is higher on the communication path for check valve 12e side than on the small pressure-receiving area chamber 9 side, the pressure difference between the two sides moves the supply-side check valve 13 to the step 11b in the cylinder 11. This causes the working fluid in the communication path for check valve 12e to flow into the small pressure-receiving area chamber 9 through between the end portion of the medium-diameter portion 12f of the supply-side guide member 12 and the supply-side check valve 13 and between the outer periphery of the supply-side check valve 13 and the inner periphery of the cylinder 11, then through the communication paths 13a of the supply-side check valve 13 (see FIG. 3).

When the pressure is higher on the small pressure-receiving area chamber 9 side than on the communication path for check valve 12e side, the pressure difference between the two sides moves the supply-side check valve 13 until the valve is pressed against the medium-diameter portion 12f of the supply-side guide member 12. As a result, the flow path between the end portion of the medium-diameter portion 12f of the supply-side guide member 12 and the supply-side check valve 13 is closed, so that no working fluid flows. Thus, the supply-side check valve 13 functions as a check valve to allow the working fluid to flow in one direction only.

On the opposite side to the contact 2 of the cylinder 11, there is a cylinder control chamber-side guide member 18 which has a two-stage convex portion including a small-diameter portion 18c and a medium-diameter portion 18b. The cylinder control chamber-side guide member 18 has, at its center, a through hole 18e used as a flow path, and the outer periphery of the medium-diameter portion 18b is fitted into the cylinder 11.

On the piston 10 side of the through-hole 18e formed in the cylinder control chamber-side guide member 18, a small-diameter through-hole portion 18a smaller in diameter than the through-hole 18e is provided. The through-hole 18e in the cylinder control chamber-side guide member 18 is communicated with outside the small-diameter portion 18c of the cylinder control chamber-side guide member 18 through a communication path for check valve 18d.

A cylinder control chamber-side check valve 15 is provided over the outer periphery of the small-diameter portion 18c of the cylinder control chamber-side guide member 18. The cylinder control chamber-side check valve 15 is cylindrically shaped, and an end portion thereof is formed as a small-diameter portion 15b having an inner diameter smaller than that of the other portion. In a sectional view, the cylinder control chamber-side check valve 15 is, for example, L-shaped. The cylindrical portion of the cylinder control chamber-side check valve has plural communication paths 15a formed therethrough. The outer diameter of the cylinder control chamber-side check valve 15 is smaller than the larger diameter of a step 11c formed on the cylinder control chamber 17 side of the cylinder 11.

The inner diameter of the small-diameter portion 15b of the cylinder control chamber-side check valve 15 is larger than the outer diameter of the small-diameter portion 18c of the cylinder control chamber-side guide member 18 such that the small-diameter portion 15b is slidable without causing much fluid leakage.

The cylinder control chamber-side check valve 15 is movable, by the pressure difference between the left and right sides thereof as seen in FIG. 1, in a stroke motion between the step 11c formed in the cylinder 11 on the left side and an end portion of the medium-diameter portion 18b of the cylinder control chamber-side guide member 18 on the right side.

The cylinder control chamber-side check valve 15 is installed such that the small-diameter portion 15b thereof is positioned on the medium-diameter portion 18b side of the cylinder control chamber-side guide member 18. When the cylinder control chamber-side check valve 15 is on the medium-diameter portion 18b side of the cylinder control chamber-side guide member 18, the communication path for check valve 18d is blocked.

In the above structure, the cylinder control chamber-side check valve 15 is moved by the pressure difference between the cylinder control chamber 17 side and the communication path for check valve 18d. When the pressure is higher on the communication path for check valve 18d side than on the cylinder control chamber 17 side, the pressure difference between the two sides moves the cylinder control chamber-side check valve 15 to the step 11c formed in the cylinder 11. This causes the working fluid in the communication path for check valve 18d to flow into the cylinder control chamber 17 through between the end portion of the medium-diameter portion 18b of the cylinder control chamber-side guide member 18 and the cylinder control chamber-side check valve 15 and between the outer periphery of the cylinder control chamber-side check valve 15 and the inner periphery of the cylinder 11, then through the communication paths 15a of the cylinder control chamber-side check valve 15 (see FIG. 8).

When the pressure is higher on the cylinder control chamber 17 side than on the communication path for check valve 18d side, the pressure difference between the two sides moves the cylinder control chamber-side check valve 15 until the valve is pressed against the end portion of the medium-diameter portion 18b of the cylinder control chamber-side guide member 18. As a result, the flow path between the end portion of the medium-diameter portion 18b of the cylinder control chamber-side guide member 18 and the cylinder control chamber-side check valve 15 is closed, so that no working fluid flows. Thus, the cylinder control chamber-side check valve 15 functions as a check valve to allow the working fluid to flow in one direction only.

The operation of the fluid-pressure drive device for a circuit breaker according to the present embodiment will be described below. When, with the drive device in the closed state shown in FIG. 1, a command for opening operation is issued, the directional control valve 6 enters a state of opening operation in which the cylinder control chamber 17 is connected to the low-pressure reservoir 8 side as shown in FIG. 2.

When the cylinder control chamber 17 is connected to the low-pressure side, the high pressure in the small pressure-receiving area chamber 9 causes the piston 10 to start moving in the direction for opening operation. This causes the pressure on the small pressure-receiving area chamber 9 side of the supply-side check valve 13 to lower and the supply-side check valve 13 to move toward the step 11b formed in the cylinder 11. As a result, the working fluid is supplied from the supply pressure chamber 12i into the small pressure-receiving area chamber 9 through, as indicated by arrow 20 in FIG. 3, the communication path for check valve 12e of the supply-side guide member 12, the outer periphery side of the supply-side check valve 13, and the communication paths 13a of the supply-side check valve 13.

At the same time, the working fluid is also supplied from the supply pressure chamber 12i to the small pressure-receiving area chamber 9 through the flow path formed between the supply flow-path forming portion 12d of the supply-side guide member 12 and the increasing-diameter portion 3b of the rod 3. This causes the piston 10 to be kept subjected to a driving force for movement in the direction for opening operation.

Subsequently, when the piston 10 moves and the projecting portion 10b of the piston 10 enters, as shown in FIG. 4, the small-diameter through-hole portion 18a of the cylinder control chamber-side guide member 18, a buffer chamber 17b surrounded by the outer periphery of the projecting portion 10b, piston 10, cylinder 11, and control chamber-side guide member 18 is formed in the cylinder control chamber 17.

The diameter of the projecting portion 10b is gradually larger from the projection end portion toward the piston 10. The diameter may change at a uniform rate or at stepped rates, i.e. stepped once or more or consecutively.

The movement of the piston 10 causes a pressure difference between the cylinder control chamber 17 and the communication path for check valve 18d, and the cylinder control chamber-side check valve 15 moves rightward as seen in FIG. 4. Thus, the flow path to the communication path for check valve 18d is closed.

As a result, the buffer chamber 17b is closed except where a gap is formed between the projecting portion 10b and the small-diameter through-hole portion 18a, and the pressure of the working fluid confined and compressed in the buffer chamber 17b starts rising, thereby generating a braking force against the piston 10. The length of the projecting portion 10b is determined such that it approximately corresponds to the position where braking of the piston 10 is to be started. The diameter changing rate of the projecting portion 10b can be set so as to achieve a desired pressure increase.

On the other hand, the decreasing-diameter portion 3a of the rod 3 gradually enters the supply flow-path forming portion 12d of the supply-side guide member 12, so that the flow path formed between the supply flow-path forming portion 12d and the decreasing-diameter portion 3a is gradually narrowed. When the contact-side sliding portion 3d of the rod 3 subsequently enters the supply flow-path forming portion 12d, the flow path is most narrowed. At the same time, with the communication path for check valve 12e of the supply-side guide member 12 communicated with the supply flow-path forming portion 12d, the flow path leading to the supply-side check valve 13 is restricted.

Thus, every flow path leading from the supply pressure chamber 12i to the small pressure-receiving area chamber 9 is narrowed. Since, in this state, the piston 10 is moving in the direction for opening operation, the pressure in the small pressure-receiving area chamber 9 greatly reduces compared with the pressure in the supply pressure chamber 12i. Hence, the driving force applied to the piston 10 for movement in the direction for opening operation is greatly reduced.

The pressure in the small pressure-receiving area chamber 9 and the deceleration of the piston 10 can be adjusted by adjusting the diameter changing rates for the decreasing-diameter portion 3a and the projecting portion 10b. It is, therefore, possible to design the decreasing-diameter portion 3a and the projecting portion 10b such that the pressure in the small pressure-receiving area chamber 9 and the deceleration of the piston 10 fall within desired ranges, respectively.

When it is desired to effect, with a reduced driving force, braking comparable to that effected with an unreduced driving force, the pressure increase required in the buffer chamber 17b can be suppressed. This allows the device to be made smaller and more reliable. In cases where a pressure increase is tolerable, the area required for braking, i.e. the pressure receiving area on the buffer chamber 17b side of the piston 10 can be reduced. In this way, design flexibility is increased.

When, with the drive device in the open state shown in FIG. 6, a command for closing operation is issued, the directional control valve 6 enters a state of closing operation in which the cylinder control chamber 17 is connected to the high-pressure working fluid side as shown in FIG. 7.

Subsequently, the pressure in the through-hole 18e in the cylinder control chamber-side guide member 18 rises, then the pressure in the communication path for check valve 18d in the cylinder control chamber-side guide member 18 rises. As a result, the cylinder control chamber-side check valve 15 moves to the step 11c side (leftward as seen in FIG. 6) in the cylinder 11.

This causes the working fluid to flow into the cylinder control chamber 17 as indicated by arrow 21 in FIG. 8. At the same time, the working fluid also flows into the cylinder control chamber 17 through the flow path formed between the small-diameter through-hole portion 18a of the cylinder control chamber-side guide member 18 and the outer periphery of the projecting portion 10b of the piston 10. This generates a driving force applied to the piston 10 for movement in the direction for closing operation.

On the other hand, the working fluid in the small pressure-receiving area chamber 9 flows into the supply pressure chamber 12i through between the inner periphery of the supply flow-path forming portion 12d and the uniform small-diameter portion 3c of the rod 3. The flow path used at this time puts up a resistance against the flowing working fluid. Since the closing operation is slow compared with the opening operation, the effect of the resistance is small, but it is necessary to secure a flow-path cross-sectional area large enough to achieve a prescribed closing operation speed.

The supply-side check valve 13 is moved by the high pressure in the small pressure-receiving area chamber 9 to be pressed to the supply-side guide member 12 side, so that the flow of working fluid from the small pressure-receiving area chamber 9 to the supply pressure chamber 12i through the supply-side check valve 13 is blocked. When the piston 10 is further moved, the flow path formed between the inner periphery of the supply flow-path forming portion 12 and the increasing-diameter portion 3b starts being narrowed. As a result, in the small pressure-receiving area chamber 9, a buffer chamber 9b is formed by the outer periphery of the increasing-diameter portion 3b, the piston 10, the inner periphery of the cylinder 11, the supply-side guide member 12, and the supply-side check valve 13.

The buffer chamber 9b is closed except where a gap is formed between the increasing-diameter portion 3b and the supply flow-path forming portion 12d. As a result, the working fluid confined in the buffer chamber 9b is compressed, and the fluid pressure starts rising to generate a force for braking the piston 10. The length of the increasing-diameter portion 3b is determined such that it approximately corresponds to the position where braking of the piston 10 is to be started. The diameter changing rate of the increasing-diameter portion 3b can be set so as to achieve a desired pressure increase.

The above structure makes it possible to reduce, toward the end of an opening operation, the drive force applied to the piston 10 for movement in the direction for opening operation. This makes it possible to suppress rising of the pressure in the buffer chamber 17b formed in the cylinder control chamber 17. Hence, the strength requirement for the fluid-pressure drive device can be lowered, the device can be made smaller, and the device reliability can be increased.

### Second Embodiment

A second embodiment of the present invention will be described below in which the flow path for high-pressure working fluid to the supply-side check valve differs from the flow path used in the first embodiment.

FIG. 10 shows a fluid-pressure drive device for a circuit breaker 100 of the second embodiment. In the following, description will be omitted for structures and parts of the fluid-pressure drive device 100 which are denoted by reference numerals identical to those used in describing the fluid-pressure drive device for a circuit breaker 1 shown in FIG. 1 or which have functions identical to those of the fluid-pressure drive device 1.

The second embodiment differs from the first embodiment in that the communication path for check valve 12e is open, at one end thereof, to the upstream side (the accumulator 5 side) of the supply through-hole 12a formed through the supply-side guide member 12 and in that the supply-side check valve 13 is structured differently from that of the first embodiment.

The supply-side check valve 13 is cylindrically shaped and has, on the inner side of an end portion thereof, a small-diameter portion 13f having an inner diameter smaller than that of the other portion. In a sectional view, the supply-side check valve 13 is L-shaped. The cylindrical portion of the supply-side check valve 13 has plural communication paths 13a formed therethrough. The outer diameter of the supply-side check valve 13 is smaller than the larger diameter of a step 11b formed on the supply side of the cylinder 11.

The inner diameter of the small-diameter portion 13f of the supply-side check valve 13 is minutely larger than the outer diameter of the small-diameter portion 12g of the supply-side guide member 12 so as to make the supply-side check valve 13 slidable without causing much leakage.

The supply-side check valve 13 is movable, by the pressure difference between the left and right sides, as seen in FIG. 10, in a stroke motion between the step 11b formed in the cylinder 11 on the left side and an end portion of the medium-diameter portion 12f of the supply-side guide member 12 on the right side.

The supply-side check valve 13 is installed such that the small-diameter portion 13f thereof is closer, than the other portion thereof, to the end portion of the medium-diameter portion 12f of the supply-side guide member 12. When the supply-side check valve 13 is positioned against the end portion of the medium-diameter portion 12f of the supply-side guide member 12, the communication path for check valve 12e is blocked.

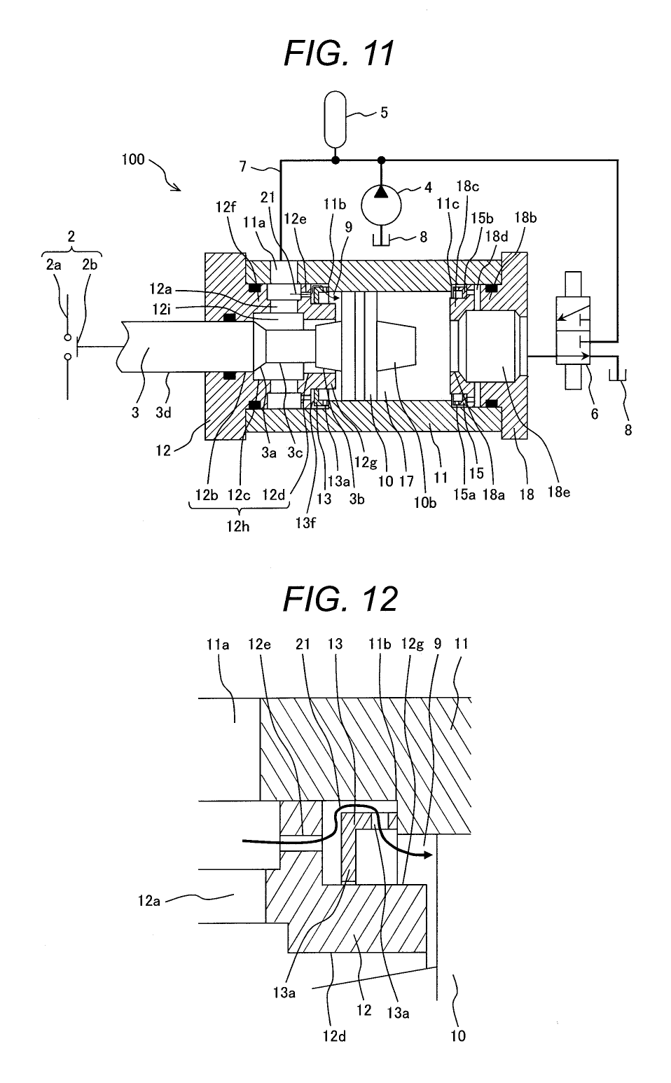

The operation of the present embodiment will be described below. When, with the drive device in a closed state shown in FIG. 10, a command for opening operation is issued, the directional control valve 6 enters a state of opening operation in which the cylinder control chamber 17 is connected to the low-pressure reservoir 8 side as shown in FIG. 11. At this time, the supply-side check valve 13 is pressed, by the high pressure on the communication path for check valve 12e side, against the step 11b formed in the cylinder 11. In this state, the high-pressure working fluid passes through the communication path for check valve 12e, passes through between the supply-side check valve 13 and the end portion of the supply-side guide member 12, passes over the outer periphery of the supply-side check valve 13, and enters the small pressure-receiving area chamber 9 through the communication paths 13a of the supply-side check valve 13.

At this time, the working fluid is also supplied to the small pressure-receiving area chamber 9 from the supply flow-path forming portion 12d. However, the flow path from the supply-side check valve 13 does not pass the supply chamber 12i, so that it is possible to reduce, when starting the opening operation, the pressure loss caused between the cylinder supply path 11a and the small pressure-receiving area chamber 9. The high-pressure working fluid continues to be supplied through the flow path indicated by arrow 21 in FIG. 12 also toward the end of the opening operation. However, since the flow path cross-sectional area reduces in the supply flow-path forming portion 12d, the total cross-sectional area of the flow paths formed on the supply-side check valve 13 side also reduces. A pressure loss can, therefore, be caused as in the first embodiment, making it possible to reduce the pressure on the small pressure-receiving area chamber 9 side. In other respects, the operation performed in the present embodiment is the same as the operation performed in the first embodiment, so that its description is omitted.

According to the present embodiment, advantageous effects similar to those of the first embodiment can be achieved and, since the working fluid is supplied to the small pressure-receiving area chamber 9 through plural flow paths for opening operation, it is possible to reduce the pressure loss at the beginning of opening operation requiring a drive force. Hence, based on an equal drive force requirement, the fluid-pressure drive device can be made smaller.

### Third Embodiment

A third embodiment of the present invention will be described below in which the rod is shaped differently from the first embodiment.

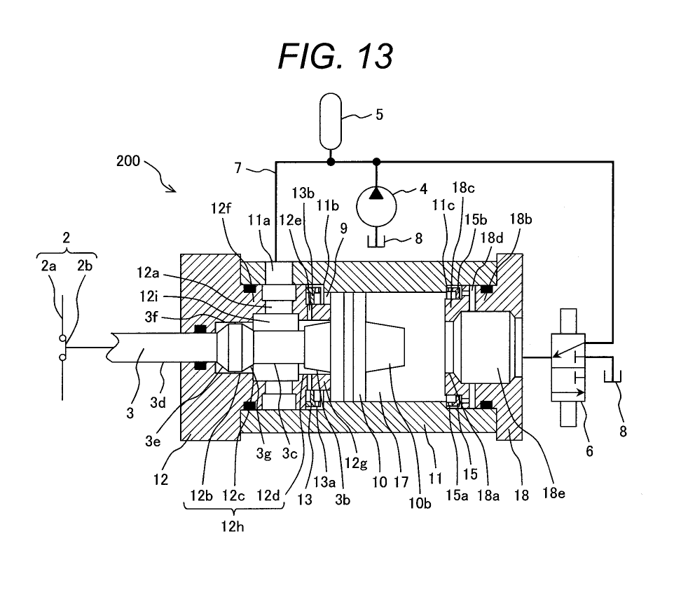

FIG. 13 shows a fluid-pressure drive device for a circuit breaker 200 of the third embodiment. In the following, description will be omitted for structures and parts of the fluid-pressure drive device 200 which are denoted by reference numerals identical to those used in describing the fluid-pressure drive device for a circuit breaker 1 shown in FIG. 1 or which have functions identical to those of the fluid-pressure drive device 1.

The third embodiment differs from the first embodiment in that the rod 3 includes, from left to right as seen in FIG. 13, a contact-side sliding portion 3d which has a uniform diameter and slides against the supply-side guide member 12, an increasing-diameter portion 3e increasing in diameter toward the piston 10, a uniform large-diameter portion 3f, a decreasing-diameter portion 3g decreasing in diameter toward the piston 10, a uniform small-diameter portion 3c which is smallest in diameter, and an increasing-diameter portion 3b increasing in diameter toward the piston 10.

The operation according to the present embodiment is identical to the operation according to the first embodiment, so that its description is omitted.

According to the present embodiment, the driving force generated is dependent on the pressure applied to the diameter difference between the maximum diameter of the piston 10 and the diameter of the contact-side sliding portion 3d. Since the contact-side sliding portion 3d has a small diameter, a large driving force can be obtained.

According to the present embodiment, advantageous effects similar to those of the first embodiment can be achieved. Even when the piston 10 is made smaller in diameter as compared with the piston 10 of the first embodiment, a driving force equivalent to that obtained according to the first embodiment can be obtained, so that designing flexibility is increased.

### LIST OF REFERENCE SIGNS

1, 100, 200 Fluid-pressure drive device for circuit breaker
2 Contact
3 Rod
4 Fluid-pressure source
5 Accumulator
6 Directional control valve
7 Supply path
8 Reservoir
9 Small pressure-receiving area chamber
10 Piston
11 Cylinder
12 Supply-side guide member
13 Supply-side check valve
15 Cylinder control chamber-side check valve
18 Cylinder control chamber-side guide member

What is claimed is:

1. A fluid-pressure drive device for a circuit breaker, comprising: a contact for passing and cutting off an electric current, the contact including a moving contact and a stationary contact; a rod connected to the moving contact; a piston which is connected to the rod and is slidably installed in a cylinder and which opens and closes the contact; a fluid pressure source for pressure-feeding a working fluid into the cylinder; and a control valve for driving the piston,
wherein the piston forms a partition between a supply pressure chamber communicated with the fluid pressure source and a small pressure-receiving area chamber which are on the moving contact side of the piston and a cylinder control chamber on the opposite side of the piston,
wherein the control valve controls supplying and discharging the working fluid to and from the cylinder control chamber, and
wherein, when the piston starts opening operation, the cross-sectional area of a flow path formed, for the working fluid, between the supply pressure chamber and the small pressure-receiving area chamber increases compared with before the piston started moving and subsequently, when the piston is to be decelerated, decreases compared with immediately after the piston started moving.

2. The fluid-pressure drive device for a circuit breaker according to claim 1,
wherein the rod has a small-diameter portion in an end portion thereof on the piston side, and
wherein the flow path is formed between an outer periphery of the small-diameter portion of the rod and a supply-side flow-path forming portion of a supply-side guide member into which the rod is inserted.

3. The fluid-pressure drive device for a circuit breaker according to claim 2, wherein the small-diameter portion has a decreasing-diameter portion decreasing in diameter toward the piston and a uniform small-diameter portion and the rod excluding the small-diameter portion has a uniform diameter.

4. The fluid-pressure drive device for a circuit breaker according to claim 2, wherein the small-diameter portion of the rod has, on the contact side of the small-diameter portion, an increasing-diameter portion increasing in diameter toward the piston and a decreasing-diameter portion decreasing in diameter toward the piston.

5. The fluid-pressure drive device for a circuit breaker according to claim 1, wherein a projecting portion is formed on the side opposite to the contact of the piston and a cylinder control chamber-side guide member is provided, the cylinder control chamber-side guide member having a through-hole into which, during opening operation, the projecting portion is inserted and through which the cylinder control chamber and the control valve are communicated with each other.

6. The fluid-pressure drive device for a circuit breaker according to claim 2, wherein a projecting portion is formed on the side opposite to the contact of the piston and a cylinder control chamber-side guide member is provided, the cylinder control chamber-side guide member having a through-hole into which, during opening operation, the projecting portion is inserted and through which the cylinder control chamber and the control valve are communicated with each other.

7. The fluid-pressure drive device for a circuit breaker according to claim 3, wherein a projecting portion is formed on the side opposite to the contact of the piston and a cylinder control chamber-side guide member is provided, the cylinder control chamber-side guide member having a through-hole into which, during opening operation, the projecting portion is inserted and through which the cylinder control chamber and the control valve are communicated with each other.

8. The fluid-pressure drive device for a circuit breaker according to claim 4, wherein a projecting portion is formed on the side opposite to the contact of the piston and a cylinder control chamber-side guide member is provided, the cylinder control chamber-side guide member having a through-hole into which, during opening operation, the projecting portion is inserted and through which the cylinder control chamber and the control valve are communicated with each other.

9. The fluid-pressure drive device for a circuit breaker according to claim 5, wherein, during opening operation of the piston, the projecting portion is inserted into the through-hole formed in the cylinder control chamber-side guide member and, at the same time, the decreasing-diameter portion of the rod is inserted into the supply-side flow-path forming portion of the supply-side guide member.

10. The fluid-pressure drive device for a circuit breaker according to claim 6, wherein, during opening operation of the piston, the projecting portion is inserted into the through-hole formed in the cylinder control chamber-side guide member and, at the same time, the decreasing-diameter portion of the rod is inserted into the supply-side flow-path forming portion of the supply-side guide member.

11. The fluid-pressure drive device for a circuit breaker according to claim 7, wherein, during opening operation of the piston, the projecting portion is inserted into the through-hole formed in the cylinder control chamber-side guide member and, at the same time, the decreasing-diameter portion of the rod is inserted into the supply-side flow-path forming portion of the supply-side guide member.

12. The fluid-pressure drive device for a circuit breaker according to claim 8, wherein, during opening operation of the piston, the projecting portion is inserted into the through-hole formed in the cylinder control chamber-side guide member and, at the same time, the decreasing-diameter portion of the rod is inserted into the supply-side flow-path forming portion of the supply-side guide member.

13. The fluid-pressure drive device for a circuit breaker according to claim 2, wherein a communication path leading from the supply-side flow-path forming portion of the supply-side guide member to the small pressure-receiving area chamber is provided, the communication path being provided, at an outer end thereof, with a check valve to allow the working fluid to flow only in one direction from the supply pressure chamber side to the supply-side flow-path forming portion side.

14. The fluid-pressure drive device for a circuit breaker according to claim 3, wherein a communication path leading from the supply-side flow-path forming portion of the supply-side guide member to the small pressure-receiving area chamber is provided, the communication path being provided, at an outer end thereof, with a check valve to allow the working fluid to flow only in one direction from the supply pressure chamber side to the supply-side flow-path forming portion side.

15. The fluid-pressure drive device for a circuit breaker according to claim 13, wherein the check valve has a cylindrical portion with a small-diameter portion formed on an inner side of the cylindrical portion and has a communication hole formed through the inner side and outer side of the cylindrical portion to be closer to the small pressure-receiving area chamber than the small-diameter portion of the cylindrical portion.
